(19) United States
(12) Patent Application Publication
(10) Pub. No.: US 2026/0059389 A1
(43) Pub. Date: Feb. 26, 2026

(54) HYBRID BACKSCATTER COMMUNICATION

(71) Applicant: Sony Group Corporation, Tokyo (JP)

(72) Inventors: Nafiseh Seyed MAZLOUM, Lund (SE); Ove EDFORS, Södra Sandby (SE)

(21) Appl. No.: 19/104,968

(22) PCT Filed: Sep. 7, 2023
(86) PCT No.: PCT/EP2023/074688

§ 371 Date: Feb. 19, 2025

(30) Foreign Application Priority Data
Sep. 12, 2022 (SE) 2251054-9

(51) Int. Cl. H04W 28/18

(52) U.S. Cl. CPC H04W 28/18

(57) ABSTRACT

Examples disclose a method, performed by a backscatter signal receiving node of a communication network, for receiving and decoding a backscatter signal produced by a wireless backscatter device by modulating incoming radiation, wherein the communication network comprises a plurality of nodes, including the backscatter signal receiving node and an emitter node, communicating in accordance with a predefined protocol, the method comprising upon an ambient radiation at the wireless backscatter device being insufficient for the backscatter signal receiving node to receive and decode the backscatter signal, sending, by the backscatter signal receiving node to the emitter node, a message triggering the emitter node to emit radiation that will increase a radiation level at the wireless backscatter device. Further examples disclose a method performed by the emitter node. Moreover, examples disclose a backscatter signal receiving node and an emitter node.

### TECHNICAL FIELD

Various examples generally relate to transmitting data using backscatter communication.

### BACKGROUND

Modern data transmission relies to a large extend on wireless communication. Conventional radio communication requires transmitting devices to generate radio signals using components such as digital-to-analog converters (DACs), mixers, oscillators and power amplifiers and receiving devices using components low noise amplifiers, mixers, oscillators, and analog-to-digital converters (ADCs) to receive the radio signals. Usually, devices participating in wireless communication are battery powered and the aforementioned components for wireless communication consume a substantial amount of the energy provided by the battery. Hence, the batteries will have to be recharged or replaced regularly. With an increasing amount of battery powered devices participation in wireless communication, this may not be feasible anymore. For example, a number of one trillion Internet-of-things (IoT) devices worldwide each having a 10-year battery lifetime would already imply that 274 billion batteries would have to be changed every single day. However, in several use cases a 10-year battery lifetime may not even be achievable with known technologies.

Moreover, battery recycling is still insufficient. In 2018, 191 000 tons of portable batteries were sold in the European Union but only less than half of said quantity, i.e. 88 000 tons of used portable batteries, is collected as waste to be recycled. The demand for new batteries has to be reduced, too, in view of the limited natural resources required for battery production.

In Kim, Sung Hoon, and Dong In Kim. “Hybrid backscatter communication for wireless-powered heterogeneous networks.” IEEE Transactions on Wireless Communications 16.10 (2017): 6557-6570, the authors propose techniques for a heterogeneous network, where a TV tower or high-power base station coexists with densely deployed small-power access points, wherein users can operate using either bistatic scattering or ambient backscattering techniques, or a hybrid of them, given that harvested energy from a dedicated or ambient RF signal may not be sufficient enough to support an existing harvest-then-transmit protocol for wireless-powered communication network.

### SUMMARY

There may be a need for facilitating data transmission involving less power consumption in established communication networks. Said need has been addressed with the subject-matter of the independent claims. Advantageous embodiments are described in the dependent claims.

Examples disclose a method, performed by a backscatter signal receiving node of a communication network, for receiving and decoding a backscatter signal produced by a wireless backscatter device by modulating incoming radiation, wherein the communication network comprises a plurality of nodes, including the backscatter signal receiving node and an emitter node, communicating in accordance with a predefined protocol, the method comprising upon an ambient radiation at the wireless backscatter device being insufficient for the backscatter signal receiving node to receive and decode the backscatter signal, sending, by the backscatter signal receiving node to the emitter node, a message triggering the emitter node to emit radiation that will increase a radiation level at the wireless backscatter device.

Additionally, examples disclose a backscatter signal receiving node comprising circuitry configured for performing the aforementioned method.

Further, examples disclose a method, performed by an emitter node of a communication network, wherein the communication network comprises a plurality of nodes, including the emitter node and a backscatter signal receiving node, communicating in accordance with a predefined protocol, the method comprising: upon receiving, from a backscatter signal receiving node, a message triggering the emitter node to emit radiation that will increase a radiation level at the wireless backscatter device, emitting radiation increasing the radiation level at the wireless backscatter device.

Moreover, examples disclose an emitter node of a communication network comprising control circuitry, wherein the control circuitry is configured for performing the aforementioned method.

### BRIEF DESCRIPTION OF THE DRAWINGS

FIG. 1 schematically illustrates backscatter communication;

FIG. 2 schematically illustrates transmission circuitry for backscatter communication;

FIG. 3 schematically illustrates transmission patterns;

FIG. 4 schematically illustrates a modulated channel;

FIG. 5 schematically illustrates receiving circuitry for backscatter communication;

FIG. 6 schematically illustrates synchronization circuitry for backscatter communication;

FIG. 7 schematically illustrates relations between a signal to interference ratio and a spreading factor;

FIG. 8 schematically illustrates a method involving backscatter communication;

FIG. 9 schematically illustrates a method involving backscatter communication; and

FIG. 10 schematically illustrates signaling enabling backscatter communication.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions and/or methods as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

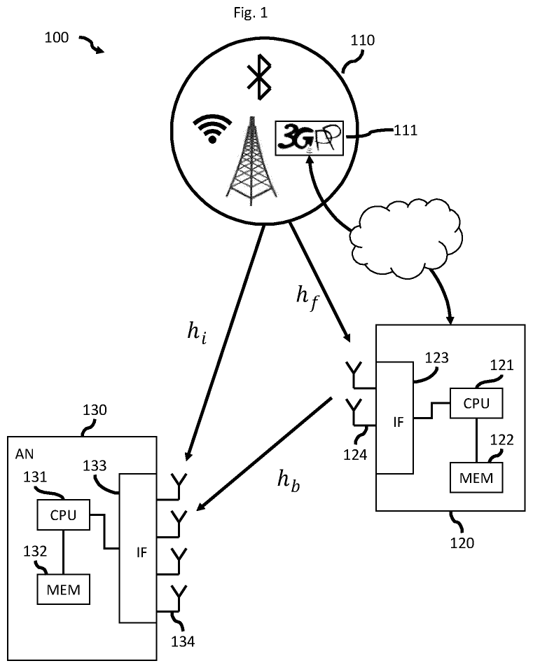

FIG. 1 illustrates a communication environment 100, in which backscatter communication may take place. The communication environment 100 comprises a wireless backscatter device 120 and a backscatter receiving node 130. The wireless backscatter device 120 includes circuitry that is implemented by a processor 121, a non-volatile memory 122 and an interface 123 that can access and control one or more antennas 124. Likewise, the backscatter signal receiving node 130 comprises circuitry that is implemented by a processor 131, a non-volatile memory 132 and an interface 133 that can access and control one or more antennas 134. As explained before, modern data transmission relies to a large extend on wireless communication. Hence, many RF sources 110 may be present in a typical environment. RF sources may comprise TV towers, cellular base stations, Bluetooth transmitters and Wi-Fi access points.

Instead of generating and transmitting radio waves using power hungry components, modulating already existing ambient RF signals may allow for substantial power savings. Such an approach is also known as backscatter communication (BSC).

As shown in FIG. 1, the backscatter signal receiving node 130 may receive the ambient RF signals via an interference channel hᵢ. In addition, the backscatter signal receiving node 130 may receive the ambient RF signals via a further channel h_{f}h_{b} provided by a wireless backscatter device 120. The wireless backscatter device 120 may influence said channel h_{f}h_{b} by backscatter modulation, h_{b} by controlling. In particular, the wireless backscatter device 120 may modulate, e.g. h_{f} reflect or absorb, an incoming ambient signal received via the channel h_{f}. BSC depends on radiation being present at the location of the wireless backscatter device 120 which may be modulated. The wireless backscatter device 120 itself may be unable to determine that no (or not sufficient) radiation is present at the location at the wireless backscatter device 120. The wireless backscatter device 120 may perform backscatter modulation nevertheless. It may be the backscatter signal receiving node 130 which identifies that a receive property of incoming backscatter signal is not sufficient for decoding the backscatter signal and conclude that the radiation at the wireless backscatter device 120 is insufficient.

A communication network may comprise a plurality of nodes communicating in accordance with a predefined protocol. In particular, the nodes may communicate with each other using a protocol as predefined by the 3GPP, IEEE, Wi-Fi, LoRa, Bluetooth. The backscatter signal receiving node 130 corresponds to such a node of the communication network. For example, the backscatter signal receiving node 130 may correspond to a node of a communication network as standardized by the 3rd Generation Partnership Project (3GPP). In some scenarios, the backscatter signal receiving node 130 may correspond to an access node (AN) of the communication network. For example, the backscatter signal receiving node 130 may correspond to a base station (BS) and/or a gNB of a 3GPP communication network. The term backscatter signal receiving node 130 may refer to any node having the capability to receive a backscatter signal.

One or more of the RF sources 110 may correspond to nodes of the communication network, too. For example, RF source 111 may correspond to a node of the communication network. An RF source 111 having the capability to emit radiation that will increase a radiation level at the wireless backscatter device 120 may be called an emitter node 111. For example, the RF source 111 may increase its transmission power resulting not only but also in a higher radiation level at the wireless backscatter device 120.

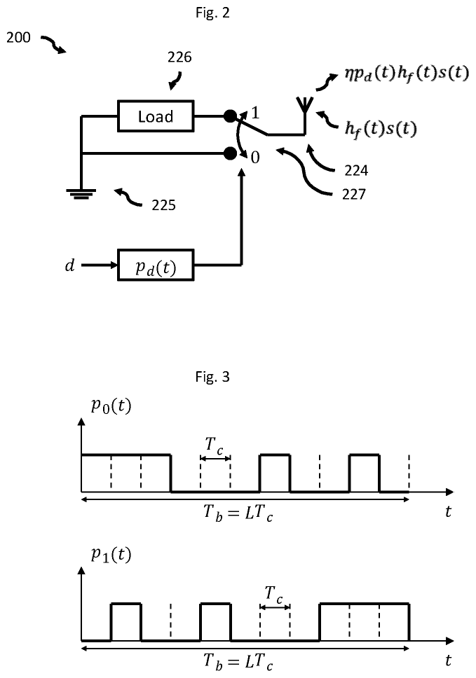

FIG. 2 illustrates possible circuitry 200 of the wireless backscatter device 120. The wireless backscatter device 120 receives the signal s (t) arriving at the wireless backscatter device 120 via the channel h_{f} with antenna 224. In response to a data bit d, the wireless backscatter device 120 reflects or absorbs the incoming signal h_{f}(t)s(t) depending on whether a pattern pa prescribes connecting the antenna 224 to ground 225 (i.e., p_{d}(t)=0) or to the load 226 (i.e., p_{d}(t)=1). Thus, the wireless backscatter device 120 may pass the signal η p_{d}(t)h_{f}(t)s(t), wherein the term η is indicative of the reflection efficiency. The pattern p_{d}(t) may be selected based on the data bit value of the data bit d. Modulating incoming (ambient) radiation by a wireless backscatter device 120 is not necessarily limited to absorbing and/or passing (I.e., transmitting or reflecting) the incoming (ambient) radiation. Modulating may comprise any method of changing an amplitude and/or phase of incoming radiation.

The circuitry of the wireless backscatter device 120 used for modulating the load applied to the antenna 224 shown in FIG. 2 consists only of a switch 227 and a load (i.e., impedance) 226. Thus, the circuitry may be of low complexity and very energy efficient.

FIG. 3 illustrates a first pattern p₀(t) associated with a data bit value zero and a second pattern p₁(t) associated with a data bit value one. Both patterns comprise a number of L chips. The term “chip” may denote a certain time interval. The chips have a predetermined duration T_{c}. Accordingly, the total duration of the patterns, which may also be called bit time, is T_{b}=L T_{c}. The first transmission pattern p₀(t) and the second transmission pattern p₁(t) are selected to have an equal number of chips with level zero. This implies that the number of chips with level one is also the same for both the first transmission pattern p₀(t) and the second transmission pattern p₁(t). The first pattern p₀(t) and/or second pattern p₁(t) may be structured as On-Off-Keying (OOK) sequences with levels one and zero.

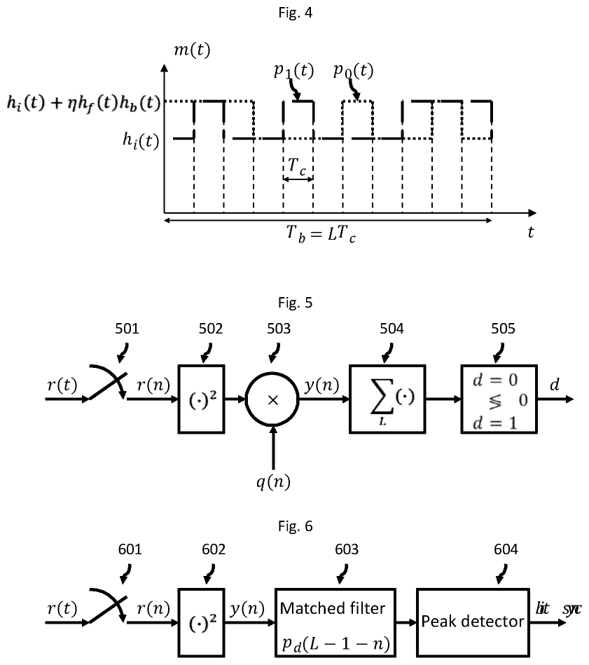

FIG. 4 illustrates a modulation factor m(t) experienced by a backscatter signal receiving node 130 under the assumption that variations of the non-modulated channel hᵢ(t) are negligible during the bit time T_{b}=L T_{c}. The modulation factor m(t) are shown for a situation when the wireless backscatter device 120 applies the first pattern p₀(t) and for a situation when the wireless backscatter device 120 applies the second pattern p₁(t).

The modulation factor m(t) may be expressed as

$$m ( t ) = {h}_{i} ( t ) + η \cdot {h}_{f} ( t ) {h}_{b} ( t ) {p}_{d} ( t )$$

wherein hᵢ represents the non-modulated interference channel, η the reflection efficiency of the wireless backscatter device 120, h_{f}(t) the channel between the ambient source 110 and the wireless backscatter device 120, h_{b}(t) the channel between the wireless backscatter device 120 and the backscatter signal receiving node 130, and p_{d}(t) the pattern applied by the wireless backscatter device 120.

Thus, the backscatter signal receiving node 130 may receive the following signal

$$r ( t ) = ( {h}_{i} ( t ) + η \cdot {h}_{f} ( t ) {h}_{b} ( t ) {p}_{d} ( t ) ) s ( t )$$

FIG. 5 illustrates a method of receiving a data bit d transmitted by the wireless backscatter device 120 by the backscatter signal receiving node 130. In particular, FIG. 5 illustrates decoding the received signal r(t) by the backscatter signal receiving node 130 (FIG. 1).

At 501, the received signal r(t) may be sampled according to the predetermined duration T_{c} to obtain a received pattern r(n) representing the data bit d. At 502, the elements of the received pattern r(n) may be transformed to obtain only positive values (e.g., the elements may be squared or an absolute value of the elements may be determined) and afterwards, at block 503, multiplied with a corresponding element of a third pattern q(n). The elements of the third pattern q(n) may be defined as follows:

$$q ( n ) = \{ \begin{matrix}1 , & {p}_{1} ( n ) = 1 ∧ {p}_{0} ( n ) = 0 \\ - 1 , & {p}_{1} ( n ) = 0 ∧ {p}_{0} ( n ) = 1 \\ 0 , & otherwise\end{matrix}$$

if

$$\vert \frac{η {h}_{f} {h}_{b}}{{h}_{i}} + 1 \vert > 1$$

otherwise as the negation of the above definition.

This may result in a fourth pattern y(n). A sum over all L members of the fourth pattern y(n) may be calculated at 504:

$${\sum }_{L} y ( n )$$

The result may be compared with zero to obtain the value of the data bit at 505:

$$d = \{ \begin{matrix}0 , & {\sum }_{L} y ( n ) < 0 \\ 1 , & {\sum }_{L} y ( n ) > 0\end{matrix}$$

The data bit value may be decoded to be zero, if the sum is smaller than zero. Correspondingly, the data bit value me decoded to be one, if the sum is larger than zero.

It is in particular the choice of the same amount of chips having the level zero for the first transmission pattern p₀(t) and the second transmission pattern p₁(t) that permits the particularly simple method for decoding the received signal. In particular, it may allow for eliminating the need for an estimation of a detection threshold for a Maximum Likelihood (ML) detector at the backscatter signal receiving node. It may also allow for omitting pilot information for this purpose. All this may contribute to a very simple and low-power detection scheme.

The proposed transmission of a single data bit across L chips may allow for substantial processing gains at the backscatter signal receiving node helping to overcome a high interference level associated with backscatter communication. The processing gain may be adjusted appropriately by selecting the value of L.

In some examples, the transmission patterns p₀(t) and p₁(t) may be selected to have a peak to off-peak auto-correlation ratio of at least L/2. This may allow for synchronization using the patterns p₀(t) and p₁(t) having the same bit time T_{b}=L·T_{c}, i.e. the same number of L chips.

FIG. 6 schematically illustrates circuitry which may be used by a backscatter signal receiving node for bit synchronization. At 601, the received signal r(t) may be sampled according to the predetermined duration T_{c} to obtain a received pattern r(n) representing the data bit d. At 602, the elements of the received pattern r(n) may be transformed to obtain only positive values (e.g., the elements may be squared or an absolute value of the elements may be determined). At 603, matched filters p_{d}(L−1−n) may be applied to the received pattern y(n). After application of the filters, a peak may be detected (604) to obtain a bit synchronization signal bit sync.

It is the very nature of ambient RF signals that their occurrence is not necessarily deterministic. For example, ambient signals may not be present at a point in time in which the wireless backscatter device is to transmit data bits to the backscatter signal receiving node.

Thus, there may be a need to support and/or enable and/or facilitate backscatter communication under variable RF environment conditions.

Accordingly, examples disclose a method, performed by the backscatter signal receiving node of the communication network, for receiving and decoding a backscatter signal produced by the wireless backscatter device by modulating incoming radiation. The communication network comprises a plurality of nodes communicating in accordance with a predefined protocol. The plurality of nodes includes the backscatter signal receiving node and one or more emitter nodes. The backscatter signal receiving node may determine whether ambient radiation at the wireless backscatter device is sufficient for the backscatter signal receiving node to receive and decode the backscatter signal. Upon an ambient radiation at the wireless backscatter device being insufficient for the backscatter signal receiving node to receive and decode the backscatter signal, the backscatter signal receiving nodes sends, to the emitter node, a message triggering and/or instructing the emitter node to emit radiation that will increase a radiation level at the wireless backscatter device. The message may be sent in accordance with the predefined protocol for the communication network in which BSC is to take place.

Thus, backscatter communication benefits from the fact that, in contrast to other RF sources like, e.g., a TV tower, the one or more emitter nodes are nodes of the communication network and may be controlled by other nodes of the communication network, in particular directly or indirectly by the backscatter signal receiving node, using a predefined protocol.

BSC without specifically using an emitter node to increase a radiation level at the wireless backscatter device may be called ambient BSC. BSC using one or more emitter node to increase a radiation level at the wireless backscatter device may be called bistatic BSC.

The backscatter signal receiving node may identify the one or more emitter nodes being able to emit radiation that will increase a radiation level at the wireless backscatter device. For example, the emitter nodes may continue communicating with another node of the communication over a radio channel using a higher transmission power. The higher transmission power used for the communication between the nodes may result in a higher radiation level at the wireless backscatter device, too. For example, the communication network may comprise several user equipment (UE) nodes. The backscatter signal receiving node may identify that one or more UEs are in the vicinity of the wireless backscatter signal device and may be able to emit radiation that will increase a radiation level at the wireless backscatter device. For example, two UEs may communicate with each other using device-to-device communication on a radio channel. For example, the two UEs may communicate using a protocol and/or frequency range as specified by the Bluetooth Special Interest Group or as specified by IEEE 802.11 (Wi-Fi). The two UEs may continue using the same protocol and/or frequency range but increase the transmission power resulting in a higher radiation level at the wireless backscatter device. In other examples, the emitter nodes may be triggered to change the original frequency they use for communicating with each other to a new frequency. Thus, the radiation level at a certain frequency at the wireless backscatter device may be increased. This may result in a backscatter signal received by wireless backscatter signal receiving node being less disturbed by other sources also emitting at the original frequency.

In some examples, identifying a node of the communication network as emitter node may comprise receiving, from the emitter node, a message indicative of the emitter node being capable and/or able to emit radiation that will increase a radiation level at the wireless backscatter device. Some communication networks may comprise reflective relaying device (RRD), e.g. an RRD as described in WO 2022/129262 A2. An RRD may be able to direct radiation from an RF source to the wireless backscatter signal device and, therefore, be able to emit radiation that will increase a radiation level at the wireless backscatter device. Thus, an emitter node may be implemented by an RRD, too.

The message triggering the emitter node to emit radiation that will increase a radiation level at the wireless backscatter device may be indicative of at least one of a position of the wireless backscatter device and/or a direction to the wireless backscatter device, a frequency of the to be emitted radiation, a frequency range of the to be emitted radiation, a band power level of the to be emitted radiation, and an emitting schedule of the to be emitted radiation.

In case the message triggering the emitter to emit radiation is indicative of a position of the wireless backscatter device, for example indicative of a geographical location of the wireless backscatter device, the emitter node may direct the radiation to the wireless backscatter device which may further improve the signal to interference ratio and improve BSC.

The term emitting schedule refer to a schedule for emitting and/or transmitting the radiation by the emitter node. The emitting schedule may be indicative of at least one of: a duration for the emission of radiation, a point in time for starting the emission of radiation, a point in time for stopping the emission of radiation, a time span between successive emissions of radiation. In some examples, the time span may be indicative of a periodicity of emissions of radiation. In other examples, a time span between a first pair of successive emissions of radiation may be different to a time span between a second pair of successive emissions of radiation. In particular, the emitting schedule may be indicative of an irregular emission of radiation.

In some examples, the backscatter signal receiving node may send the message triggering the emitter node to emit radiation on a radio channel directly to the emitter node. Sending the message triggering the emitter node to emit radiation to the emitter node may involve using sidelink communication, in particular sidelink communication as specified by the 3GPP. Other examples may prescribe that the backscatter signal receiving node sends the message triggering the emitter node to emit radiation via the communication network. In particular, sending the message triggering the emitter node to emit radiation to the emitter node may involve routing the message to further nodes of the communication network.

In some examples, the backscatter signal receiving node may obtain, from the emitter node, an acknowledge message in response to sending the message triggering the emitter node to emit radiation. However, in other examples, the backscatter signal receiving node may derive proper reception of the message triggering the emitter node to emit radiation from a changing signal to interference ratio or raw bit error rate.

The backscatter signal receiving node may obtain, from the emitter node, a message indicative of the emitter node being able to emit radiation. The message indicative of the emitter node being able to emit radiation may be obtained directly from the emitter node or via the communication network.

The message triggering the emitter node to emit radiation may be performed in response to a receive property of a previously received pattern. For example, the wireless backscatter device may transmit a data bit by modulating incoming radiation from an ambient RF source. The backscatter signal receiving node may decode the corresponding received pattern representing the data bit.

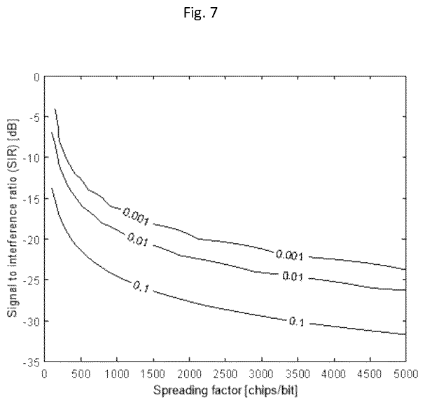

FIG. 7 shows the result of theoretical calculations, which have been verified by simulations, illustrating the relation between a signal to interference ratio and a required spreading factor for three different raw bit error rates (0.1, 0.01, and 0.001) assuming a non-fading environment. The spreading factor corresponds to the predefined number L of chips per transmission pattern p_{d}(t).

For instance, approximately 1300 chips per transmission pattern p_{d}(t) might be sufficient to achieve a raw bit error rate of 0.01 in an environment having a signal to interference ratio of −20 db.

Thus, to achieve a given raw bit error rate, the spreading factor may have to be increased if the signal to interference ratio decreases. A larger spreading factor may result in an increased delay and/or a reduced data bit transmission rate.

In some scenarios, the signal to interference ratio decreases while the backscatter signal receiving node transmits data bits. The wireless backscatter device may not be able to change the spreading factor. Hence, in response to a receive property of a previously received pattern, the backscatter signal receiving node may send, to an emitter node of the communication network, a message triggering the emitter node to emit radiation. Thus, in case the receiving device detects a too high raw bit error rate, the signal to interference ratio may be increased by the additional radiation emitted by the emitter node.

In examples, a data transmission quality requirement may be identified and sending the message triggering the emitter to emit radiation is performed based on a data transmission quality requirement. Data transmission quality requirements may include at least one of a data transmission bit rate and a data transmission delay. As explained above, a larger spreading factor may result in an increased delay and/or a reduced data bit transmission rate. Vice versa a shorter delay and/or an increased data bit transmission rate may require a short spreading factor. The additional emission of radiation by the emitter node may result in a signal to noise ratio allowing for a short spreading factor while complying with raw bit error requirements. In some scenarios, the data transmission quality requirement may be obtained, by the backscatter signal receiving node, by higher layer signalling. For example, the data transmission quality requirement may be obtained on an application layer.

In some scenarios, the wireless backscatter device may transmit a backscatter signal on its own motion. For example, the wireless backscatter device may comprise a sensor transmitting a backscatter signal, if a certain measured sensor value exceeds a prescribed limit. In other examples, the sensor may regularly transmit a backscatter signal indicative of a measured sensor value. In some examples, the backscatter signal receiving node may transmit, to the wireless backscatter device, a message triggering the wireless backscatter device to transmit a data bit by modulating incoming radiation. Thus, communication may be initiated by the backscatter signal receiving node.

According to examples, the backscatter signal receiving node may transmit, in response to a received backscatter signal, a message to the emitter node to stop emitting radiation. This may avoid unnecessary power consumption of the emitter node, when the wireless backscatter device no longer needs to transmit backscatter signals and/or ambient RF sources provide enough radiation to obtain a sufficient signal to noise ratio.

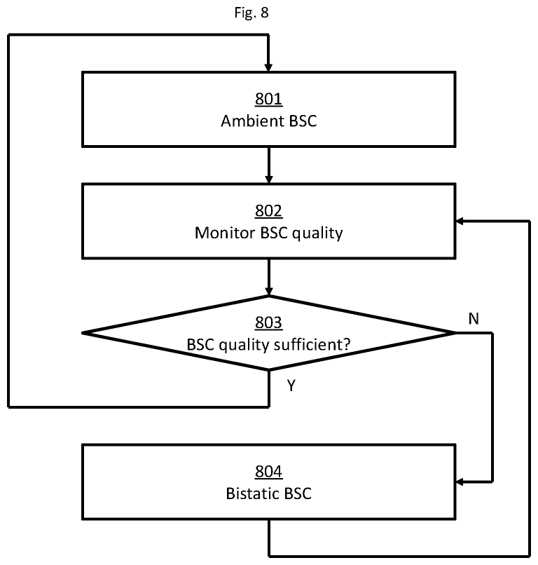

FIG. 8 illustrates a method involving BSC. As explained above, parts of the method are performed by nodes of a communication network. The nodes may correspond to electrical devices being configured to execute a program code that is embodied in a non-transitory computer readable medium programmed to perform any number of the functions and/or methods as disclosed.

At 801, ambient BSC may be performed. A backscatter signal may be produced by a wireless backscatter device by modulating incoming ambient radiation. The BSC quality may be monitored by the backscatter signal receiving node (802) of a communication network. The BSC quality may include a reception property of an incoming backscatter signal. For example. BSC quality may include a reception power of an incoming backscatter signal. In particular, the backscatter signal receiving node may identify whether a received backscatter signal meets a decoding criterion (803). A decoding criterion may define characteristics of the backscatter signal required to properly decode the signal. For example, the decoding criterion may refer to a required raw error bit rate and/or a required power level of the backscatter signal at the backscatter signal receiving node. The backscatter signal receiving node may determine a reception quality of the backscatter signal. If the backscatter signal meets the decoding criterion, the backscatter signal receiving node may identify the ambient radiation at the wireless backscatter device to be sufficient for the backscatter signal receiving node to receive and decode the backscatter signal and ambient BSC may be continued. In some scenarios, in case the backscatter signal does not meet the decoding criterion, the backscatter signal receiving node may identify the ambient radiation at the wireless backscatter device to be sufficient for the backscatter signal receiving node to receive and decode the backscatter signal and bistatic BSC may be performed (804). In particular, the backscatter signal receiving node may send, to an emitter node of the communication network, a message triggering the emitter node to emit radiation that will increase a radiation level at the wireless backscatter device.

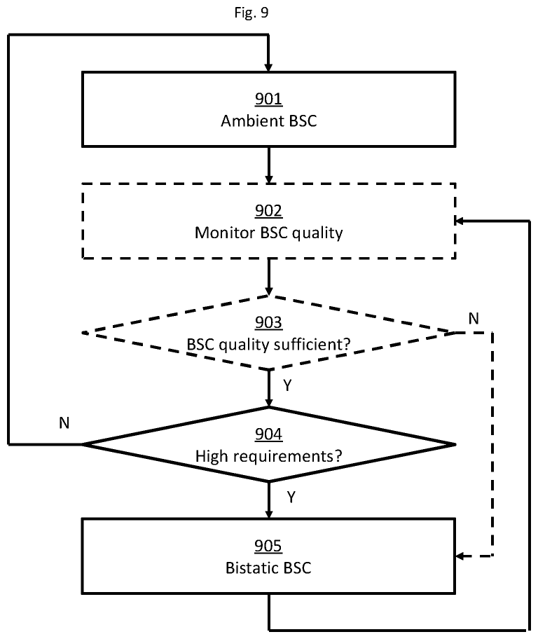

FIG. 9 illustrates a further method involving BSC. At 901, ambient BSC may be performed. A backscatter signal may be produced by a wireless backscatter device by modulating incoming ambient radiation. The BSC quality may be monitored by the backscatter signal receiving node (902) of a communication network. The backscatter signal receiving node may identify whether a received backscatter signal meets a decoding criterion (903). The backscatter signal receiving node may determine a reception quality of the backscatter signal. If the backscatter signal meets the decoding criterion, the backscatter signal receiving node may identify whether a high data transmission quality is to be obtained (904). For example, the backscatter signal receiving device may identify whether a higher data transmission bit rate and/or a shorter data transmission delay is required by higher layer signalling, for example signalling on an application layer. Higher layer signalling may refer to signalling on a higher layer of the predefined protocol compared to the lay used for communicating the message triggering the emitter node to emit radiation that will increase a radiation level at the wireless backscatter device.

The backscatter signal receiving node may identify that said higher data transmission quality requires a higher radiation level at the wireless backscatter device. Accordingly, the backscatter signal receiving node may send, to at least one emitter node, a message triggering the emitter node to emit radiation that will increase a radiation level at the wireless backscatter device and initiate bistatic BSC (905).

If the backscatter signal receiving node determines at 904 that no high data transmission quality is to be obtained, ambient BSC 901 may be performed.

In case the backscatter signal does not meet the decoding criterion, the backscatter signal receiving node may initiate bistatic BSC 905, too.

The steps 902 and 903 may be optional. Thus, the backscatter signal receiving node may switch from ambient BSC to bistatic BSC without taking an actual, in particular measured, reception property into account. The backscatter signal receiving node may switch from ambient BSC to bistatic BSC only depending on a data transmission quality requirement.

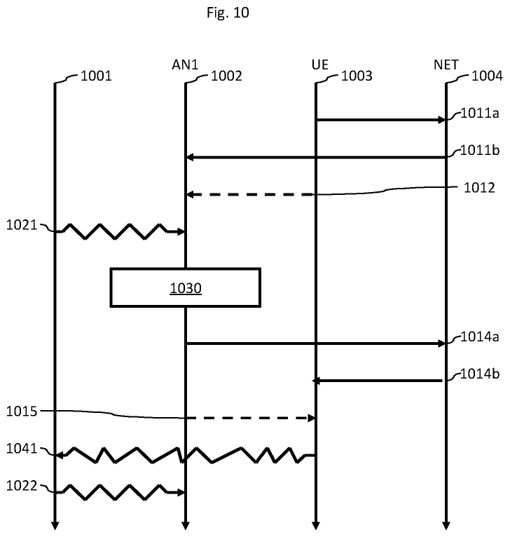

FIG. 10 schematically illustrates signalling enabling backscatter communication. Signalling may take place between a wireless backscatter device 1001, a backscatter signal receiving node 1002, which may be implemented by an access node (AN), an emitter node 1003, which may be implemented by a UE, and the network 1004.

The emitter node 1003 may provide, via the network 1004, to the backscatter signal receiving node 1002, a message 1011a, 1011b indicative of the emitter node 1003 being able to emit radiation. In particular, the message 1011a, 1011b may be indicative of the emitter node 1003 being able to emit radiation for facilitating BSC. It may also be possible that the backscatter signal receiving node 1002 receives a message 1012 indicative of the emitter node 1003 being able to emit radiation directly from the emitter node 1003.

The backscatter signal receiving node 1002 may receive a backscatter signal 1021 produced by the wireless backscatter device by modulating incoming radiation. Thus, the backscatter signal receiving node 1002 may receive the backscatter signal 1021 using BSC. As long as no dedicated emitter node is involved in the communication, the BSC may be considered ambient BSC.

At 1030, the backscatter signal receiving node 1002 may identify an ambient radiation at the wireless backscatter device 1001 as being insufficient for the backscatter signal receiving node 1002 to receive and decode the backscatter signal 1021. BSC depends on radiation being present at the location of the wireless backscatter device 1001 which may be modulated. The wireless backscatter device 1001 itself may be unable to determine that no (or not sufficient) radiation is present at the location at the wireless backscatter device 1001. The wireless backscatter device 1001 may perform backscatter modulation nevertheless. It may be the backscatter signal receiving node 1002 which identifies that a receive property of incoming backscatter signal is not sufficient for decoding the backscatter signal and conclude that the radiation at the wireless backscatter device 1001 is insufficient. For example, the backscatter signal receiving node 1002 may measure a signal quality of an incoming backscatter signal. For example, the backscatter signal receiving node 1002 may determine that a difference between a high and a low level of a received backscatter signal is not sufficient for reliably decoding the incoming backscatter signal.

In response to said finding, the backscatter signal receiving node 1002 may send, to the emitter node 1003, a message 1011a, 1011b, via the network 1004, triggering the emitter node 1003 to emit radiation. It may also be possible that the backscatter signal receiving node 1002 sends a message 1015 trigger the emitter node 1003 to emit radiation directly to the emitter node 1003.

In response to the message 1011a, 1011b and/or 1015, the emitter node 1003 emits radiation 1041.

The backscatter signal receiving node 1002 may receive data bits 1022 transmitted by the wireless backscatter device by modulating incoming radiation, wherein the strength of the incoming signal is increased by the emission of radiation by the emitter node 1003. Hence, the backscatter signal receiving node 1002 may receive data bits 1022 using bistatic BSC.

Summarizing, at least the following EXAMPLES have been described above:

EXAMPLE 1. A method, performed by a backscatter signal receiving node (130) of a communication network, for receiving and decoding a backscatter signal produced by a wireless backscatter device (120) by modulating incoming radiation, wherein the communication network comprises a plurality of nodes, including the backscatter signal receiving node (130) and an emitter node (111), communicating in accordance with a predefined protocol, the method comprising
upon (1030; 803) an ambient radiation at the wireless backscatter device (120) being insufficient for the backscatter signal receiving node (130) to receive and decode the backscatter signal,
sending (804), by the backscatter signal receiving node (130) to the emitter node (111), a message (1014a, 1014b; 1015) triggering the emitter node (111) to emit radiation (1041) that will increase a radiation level at the wireless backscatter device (120).
   EXAMPLE 2. The method of EXAMPLE 1, further comprising:
identifying a node of the communication network as emitter node (111) being able to emit radiation that will increase a radiation level at the wireless backscatter device (120).
   EXAMPLE 3. The method of EXAMPLE 2,
wherein identifying a node of the communication network as emitter node (111) comprises
   receiving, from the emitter node (111), a message (1011a, 1011b; 1012) indicative of the emitter node (111) being capable and/or able to emit radiation that will increase a radiation level at the wireless backscatter device (120).
      EXAMPLE 4. The method of any one of EXAMPLES 1 to 3,
wherein the message (1014a, 1014b; 1015) triggering the emitter node (111) to emit radiation that will increase a radiation level at the wireless backscatter device (120) is indicative of at least one of
   position of the wireless backscatter device (120),
   direction to the wireless backscatter device (120),
   a frequency of the to be emitted radiation (1041),
   a frequency range of the to be emitted radiation (1041),
   a band power level of the to be emitted radiation (1041), and
   an emitting schedule for the to be emitted radiation (1041).
      EXAMPLE 5. The method of EXAMPLE 4,
wherein the emitting schedule is at least party predefined, and/or
wherein the message triggering the emitter node to emit radiation is indicative of the emitting schedule.
   EXAMPLE 6. The method of EXAMPLE 4 or 5,
wherein the emitting schedule is indicative of at least one of,
   a duration for the emission of radiation (1041),
   a point in time for starting the emission of radiation (1041),
   a point in time for stopping the emission of radiation (1041), and
   a time span between successive emissions of radiation (1041).
      EXAMPLE 7. The method of any one of EXAMPLES 1 to 6, further comprising
receiving, from the emitter node (111), an acknowledge message in response to sending the message triggering the emitter node (111) to emit radiation (1041).
   EXAMPLE 8. The method of any one of EXAMPLES 1 to 7,
wherein sending the message triggering the emitter node (111) to emit radiation is performed upon identifying a backscatter signal produced by the wireless backscatter device (120) failing to meet a decoding criterion.
   EXAMPLE 9. The method of any one of EXAMPLES 1 to 8, further comprising
identifying a data transmission quality requirement,
wherein sending the message triggering the emitter node (111) to emit radiation (1041) is performed based on the data transmission quality requirement.
   EXAMPLE 10. The method of EXAMPLE 9,
wherein the data transmission quality requirement comprises at least one of
a data transmission bit rate,
a data transmission delay, and
a data transmission error rate.

1. A method, performed by a backscatter signal receiving node of a communication network, for receiving and decoding a backscatter signal produced by a wireless backscatter device by modulating incoming radiation,
wherein the communication network comprises a plurality of nodes, including the backscatter signal receiving node and an emitter node, communicating in accordance with a predefined protocol, the method comprising
upon an ambient radiation at the wireless backscatter device being insufficient for the backscatter signal receiving node 130) to receive and decode the backscatter signal,
sending, by the backscatter signal receiving node 130) to the emitter node, a message triggering the emitter node to emit radiation that will increase a radiation level at the wireless backscatter device.

2. The method of claim 1, further comprising:
identifying a node of the communication network as emitter node being able to emit radiation that will increase a radiation level at the wireless backscatter device.

3. The method of claim 2,
wherein identifying a node of the communication network as emitter node comprises
receiving, from the emitter node, a message indicative of the emitter node being capable and/or able to emit radiation that will increase a radiation level at the wireless backscatter device.

4. The method of claim 1,
wherein the message triggering the emitter node to emit radiation that will increase a radiation level at the wireless backscatter device is indicative of at least one of
position of the wireless backscatter device,
direction to the wireless backscatter device,
a frequency of the to be emitted radiation,
a frequency range of the to be emitted radiation,
a band power level of the to be emitted radiation, and
an emitting schedule for the to be emitted radiation.

5. The method of claim 4,
wherein the emitting schedule is at least party predefined, and/or
wherein the message triggering the emitter node to emit radiation is indicative of the emitting schedule.

6. The method of claim 4,
wherein the emitting schedule is indicative of at least one of,
a duration for the emission of radiation,
a point in time for starting the emission of radiation,
a point in time for stopping the emission of radiation, and
a time span between successive emissions of radiation.

7. The method of claim 1, further comprising
receiving, from the emitter node, an acknowledge message in response to sending the message triggering the emitter node to emit radiation.

8. The method of claim 1,
wherein sending the message triggering the emitter node to emit radiation is performed upon identifying a backscatter signal produced by the wireless backscatter device failing to meet a decoding criterion.

9. The method of claim 1, further comprising
identifying a data transmission quality requirement, wherein sending the message triggering the emitter node to emit radiation is performed based on the data transmission quality requirement.

10. The method of claim 9,
wherein the data transmission quality requirement comprises at least one of
a data transmission bit rate,
a data transmission delay,
a data transmission error rate.

11. The method of claim 1, further comprising
transmitting, to the wireless backscatter device, a signal triggering the wireless backscatter device to produce a backscatter signal by modulating incoming radiation.

12. The method of claim 1, further comprising
sending, in response to a received backscatter signal, a message to the emitter node to stop emitting the radiation that increases a radiation level at the wireless backscatter device.

13. A method, performed by an emitter node of a communication network,
wherein the communication network comprises a plurality of nodes, including the emitter node and a backscatter signal receiving node, communicating in accordance with a predefined protocol, the method comprising
upon receiving, from a backscatter signal receiving node, a message triggering the emitter node to emit radiation that will increase a radiation level at the wireless backscatter device,
emitting radiation increasing the radiation level at the wireless backscatter device.

14. The method of claim 13, further comprising
sending, to the backscatter signal receiving node, a message indicative of the emitter node being capable and/or able to emit radiation that will increase a radiation level at the wireless backscatter device.

15. A backscatter signal receiving node of a communication network comprising control circuitry, wherein the control circuitry is configured for performing a method according to claim 1.

16. The backscatter signal receiving node of claim 15,
wherein the backscatter signal receiving node is a wireless device of the communication network.

17. The backscatter signal receiving node of claim 15,
wherein the backscatter signal receiving node is an access node of the communication network.

18. An emitter node of a communication network comprising control circuitry, wherein the control circuitry is configured for performing the method of claim 14.

19. The emitter node of claim 18,
wherein the emitter node is a wireless device of the communication network.

20. The emitter node of the claim 18,
wherein the emitter node is an access node of the communication network.
